(19) United States
(12) Patent Application Publication
(10) Pub. No.: US 2003/0115250 A1
(43) Pub. Date: Jun. 19, 2003

(54) Method and system for generating a permanent record of a service at a remote printer

(76) Inventors: Kevin F. Bernier, Wrentham, MA (US); Richard A. Pineau, Andover, MA (US); Todd Lynton, Cambridge, MA (US)

Correspondence Address: Orlando Lopez, POLAROID CORPORATION, Patent Department, 784 Memorial Drive, Cambridge, MA, 02139, US

(21) Appl. No.: 10/023,245

(22) Filed: Dec. 18, 2001

(51) Int. Cl. G06F 15/16

(52) U.S. Cl. 709/201

(57) ABSTRACT

Techniques are disclosed to provide a service and generate, at the location of a remote output device, a permanent record of the service. In these techniques, before generating the permanent record, data necessary to provide the service and data necessary to provide the permanent record are processed by at least one remote server. A request for the service and the data necessary to provide the service are received, from a communications device such as a telephone or a computer, at a receiving center. The data necessary to provide the service are processed to generate data required for service. The data required for the service and other store data are processed, at a remote server, to generate input data for a specific output device. The input data for the specific output device is transmitted to the output device and rendered as a permanent record of the service.

### CROSS REFERENCE TO RELATED APPLICATIONS

This application is related to application Ser. No. 09/870,536, filed on May 30, 2001, entitled “Method and System for Remote Utilizing a Mobile Device to Share Data Objects,” which is hereby incorporated by reference in its entirety, and to application Ser. No. 09/870,538, filed on May 30, 2001, entitled “Method and System for Generating a Permanent Record of a Service Provided to a Mobile Device,” which is also hereby incorporated by reference in its entirety.

This application is also related to a comnmonly-owned and concurrently filed application Ser. No., aa/AAA,AAA, entitled “Method and Apparatus for Printing Remote Images Using of a Network-Enabled Printer” (Docket No. 8521), which is hereby incorporated by reference in its entirety.

### BACKGROUND OF THE INVENTION

1. Field of the Invention

The present invention relates to services available via communication devices. More specifically, it relates to providing a permanent record, at a remote printer, of the service rendered.

2. Background Description

It is commonplace to purchase services via communication devices. Using a telephone it is possible to purchase airline tickets, event tickets, and an entire range of merchandise. When obtaining such services via the telephone, the user must wait to receive confirmation of the completed transaction until a permanent record is received, most likely via a postal service or a courier service.

More recently the Internet, and in particular the World Wide Web (usually referred to as “the Web”), has been increasingly used for obtaining services. The Web has also enabled the expansion of the services available. It is possible to purchase airline tickets, event tickets, and other merchandise, as well as to share digital images, to obtain maps and directions, and to receive coupons and other information via the Web. Generating a permanent record for services obtained via the Web requires issuing a print command in order to print, at a printer connected to the computer used to access the Web, a page or a document obtained from the Web. A user does not have the opportunity to print at for at a remote site not connected to the computer being used to access the Web. This limitation precludes obtaining the service at one site and the permanent record at another site, as would be the case if the user wanted to share a permanent record of an image with another user at a remote site or if the user wanted to print the permanent record of a ticket at another site. Furthermore, the limitation of printing only at printers connected to the computer used to access the Web results in mobile users being required to have a printer connected to the mobile computing device.

Thus, there is a need for methods of providing a permanent record of a service at a remote printer.

### SUMMARY OF THE INVENTION

It is the primary object of this invention to provide users with the ability to obtain, at a remote printer, a permanent record of a rendered service. To satisfy this and other objects of this invention, techniques are disclosed to provide a service and generate, at the location of a remote printer, a permanent record of the service. In these techniques, before generating the permanent record, data necessary to provide the service and data necessary to provide the permanent record are processed by at least one remote server. A request for the service and the data necessary to provide the service are received, from a communications device such as a telephone or a computer, at a receiving center. The data necessary to provide the service are processed to generate data required for service. The data required for the service and other store data are processed, at a remote server, to generate input data for a specific printer. The input data for the specific printer is transmitted to the printer and rendered as a permanent record of the service.

The techniques described in the above referenced application, “Method and Apparatus for Generating a Printing Remote Images Using of a Network-Enabled Printer” (Atty. Docket No. 8521), are used to download and print the digital data. As described in that application, the remote printer includes a network communications device, such as a modem. The connection between the printer and a remote server can, for example, be established via telephone lines by initiating a call from the printer to the server. The input data for the printer is then downloaded to the printer from the server.

The communications device used to send the request for the service and the data necessary to provide the service to the receiving center can, for example, be a computer or a telephone. When a computer is used as the communications device, the request for service is sent from the computer to the receiving center via a data network. It should be apparent that the connection from the computer to the data network can be implemented by means of a modem, a direct connection to the network or several other means known in the art. The network can, for example, be the Internet. The receiving center will, in the case of a computer as a communications device connected via the Internet, include a receiving server. In one configuration, the receiving server can also be used to provide the service and also to generate the input data for the printer. Alternatively, the receiving server can move provide the service, process the data required for the service, and provide the processed data to a printing server. It should be apparent that, in a different system configuration, the receiving server can be the printing server.

When a telephone is used as the communications device, the request for the service is sent via a communications network (such as a Plain Old Telephone Service network) to the receiving center. The receiving center can be, in one embodiment, a vortal (a voice Portal). In another embodiment, the receiving center includes means for receiving the request for the service and the data required for the service and providing the request and the data to a server. From that point forward the system is the same as in the case where the communication device was a computer. In providing services, such as tickets, whether event tickets, airline tickets or other tickets, merchandise, and other services, transactions are required to complete the service. In such cases the transaction is usually completed at a transaction server. The required transaction data is sent from the service server, or the server providing the service, to the transaction server.

In cases where the providing the service does not by itself provide confirmation of the service, a message confirming that the request for service has been fulfilled can be sent either to the communication device or to the printer. When the confirming message is sent to the printer, it can be sent as input data to be printed.

It should be apparent that the request for the service can be generated via a voice portal, via a telephone call to a receiving center, via a Web enabled telephone network, via a computer, via a handheld device such as digital assistant, or other means. The communications device can be a computer, whether stationary or portable, a Web enabled telephone, a handheld computing device, a telephone, whether stationary or mobile, or other devices capable of sending information via a communications or data network. The service can be the purchase of a ticket, whether an event tickets, and airline ticket, or other type of ticket, the obtaining of a coupon, the obtaining of stamps, the obtaining of maps for a specific region, the obtaining of specific information such as restaurant reviews, menus, short reports, a digital image, or a compound document containing both text and images.

### DESCRIPTION OF THE DRAWINGS

The novel features that are considered characteristic of the invention are set forth with particularity in the appended claims. The invention itself, however, both as to its organization and its method of operation, together with other objects and advantages thereof will be best understood from the following description of the illustrated embodiment when read in connection with the accompanying drawings wherein:

FIG. 1 depicts a graphical representation of an embodiment of a system that enables the providing of a service, the service being requested from a communications device, and generating, at the location of a remote printer, a permanent record of the service;

FIG. 2 depicts a graphical representation of an embodiment of the system that enables the providing of a service and generating, at the location of the remote printer, a permanent record of the service, where input data for the printer is provided by a printing server;

FIG. 3A depicts a graphical representation of an embodiment of the system that enables the providing of a service and generating, at the location of the remote printer, a permanent record of the service, where the receiving center is a receiving/service server and the communication device is a computer;

FIG. 3B depicts a graphical representation of an embodiment of the system that enables the providing of a service and generating, at the location of the remote printer, a permanent record of the service, where the input data for the printer is provided by a printing server and the communication device is a telephone;

FIG. 4A depicts a graphical representation of an embodiment of the system that enables the providing of a service and generating, at the location of the remote printer, a permanent record of the service, where the receiving center includes a receiving server, the input data for the printer is provided by a printing server and the communication device is a telephone;

FIG. 4B depicts a graphical representation of an embodiment of the system that enables the providing of a service and generating, at the location of the remote printer, a permanent record of the service, where the receiving center is a receiving server, the input data for the printer is provided by a printing server and the communication device is a computer;

FIG. 5A depicts a flowchart of an embodiment of the method that enables the providing of a service and generating, at the location of the remote printer, a permanent record of the service;

FIG. 5B depicts a flowchart of an embodiment of the method that enables the providing of a service and generating, at the location of the remote printer, a permanent record of the service, the input data for the printer being provided by a printing server; and

FIG. 6 illustrates a sample of a ticket as the permanent record printed as a result of the methods of FIGS. 5A, 5B.

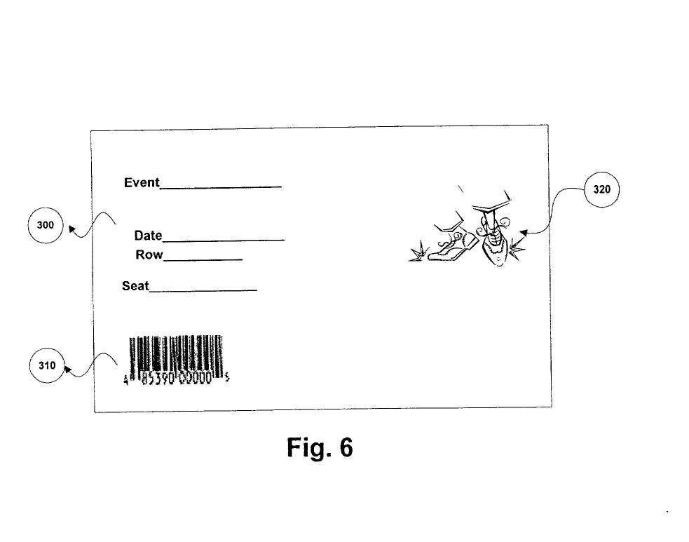

### DETAILED DESCRIPTION

To provide users with the ability to obtain, at a remote printer, a permanent record of a rendered service, a system and method for providing a service and generating, at the location of the remote printer, a permanent record of the service are disclosed. A description of an embodiment of the system and the method of this invention is given first. A detailed description of several embodiments of the system and method of this invention is then described for each embodiment.

System and Method

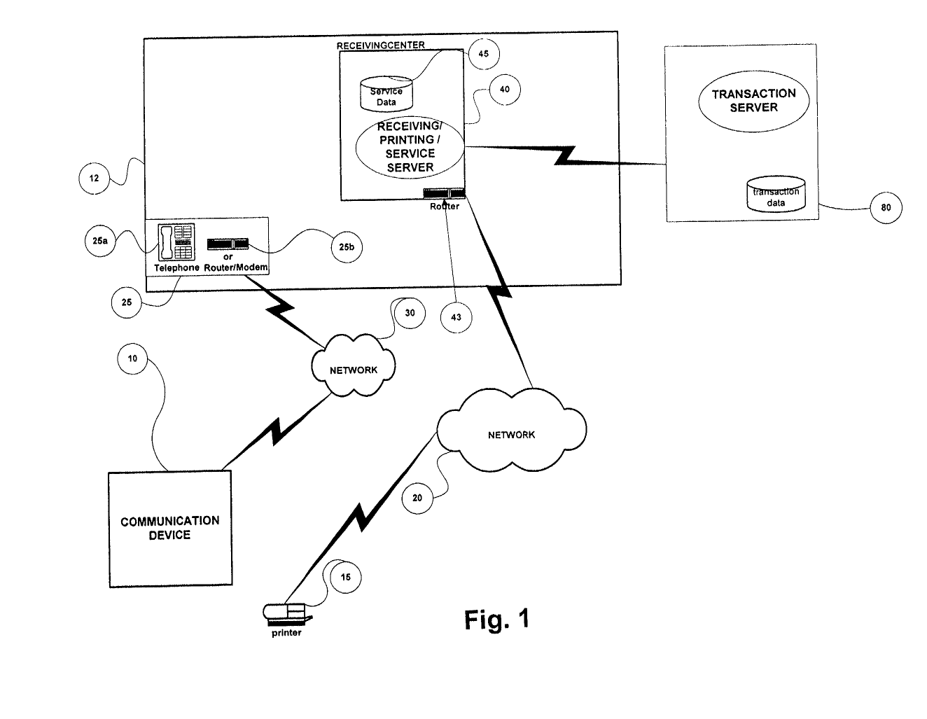

FIG. 1 depicts an embodiment of a system that enables the providing of a service, the service being requested from a communications device 10, and generating, at the location of a remote printer 15, a permanent record of the service. The communications device 10 connects through a network 30 to a receiving center 12. The communication device 10 can be a data communication device, such as a computer, or a voice communication device, such as a telephone. Similarly, the network 30 can be a data network, such as the Internet, or a communications network, such as a Plain Old Telephone Service (POTS) network or a wireless telephone network. The network 30 connects to the receiving center 12 through an input port 25, such as a telephone 25A or a router/modem 25B. The receiving center 12 includes at least one server 40. The server 40 connects through network 20 to the remote printer 15.

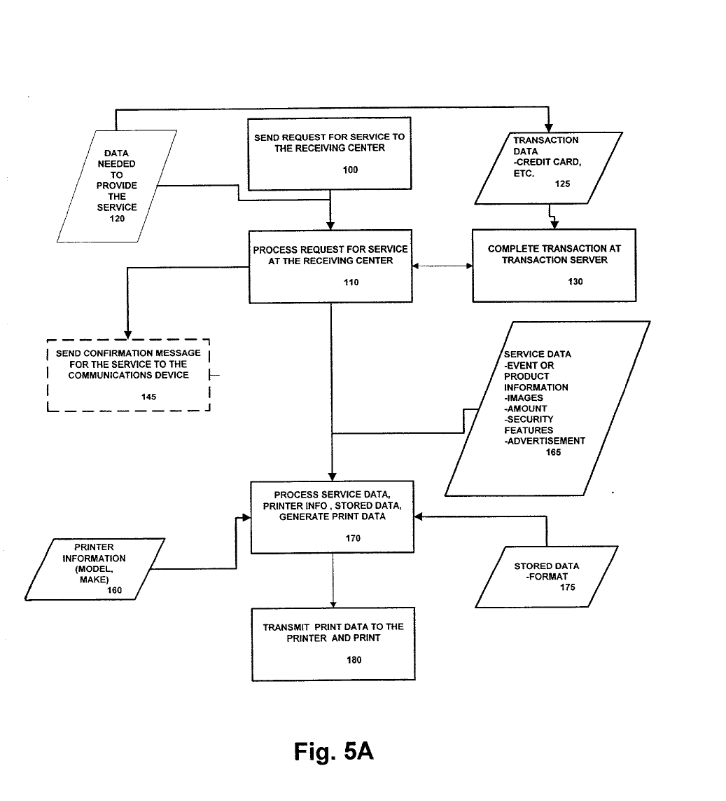

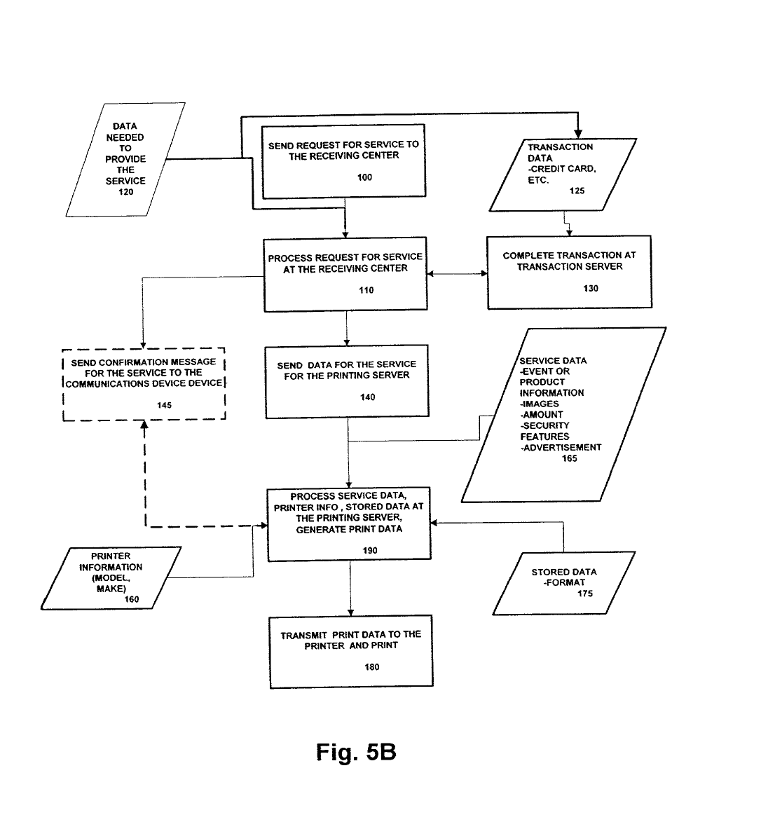

A request for a service and data necessary to provide the service (120, FIG. 5A) are sent from the communication device 10 to the receiving center 12 (step 100, FIG. 5A). The service can be the purchase of a ticket, whether an event tickets, an airline ticket, or other type of ticket, the obtaining of a coupon, the obtaining of stamps, the obtaining of maps for a specific region, the obtaining of specific information such as restaurant reviews, menus, short reports, a digital image, or a compound document containing both text and images. The data needed to provide the service is different for every type of service and can include, for example, the event and the date of event in the case of an event ticket, or an image or the location (location being, for example, a URL or a web address, in one embodiment) of an image, or a location (location in this case being a physical address or identifier, such as a number and a street name or a name of a landmark) for which a map is desired, or other information depending on the requested service. The data needed to provide the service can also include the data, such as credit card information or account information, necessary for processing the transaction (125, FIG. 5A). The request for the service and the data necessary to provide the service (120, FIG. 5A) are processed (step 110, FIG. 5A), by the server 40, to generate data required for the service (165, FIG. 5A).

The difference between the data necessary to provide the service (120, FIG. 5A) and the data required for the service (165, FIG. 5A) can best be understood by means of an example. When the service requested is the providing of directions from one location to another location, the data necessary to provide the service include the addresses of both locations and the data required for the service comprises an image of a map, the detailed directions for travel from one location to the other location, and an estimate of travel time.

Included in the data necessary to provide the service (120, FIG. 5A) are of means for identifying the user and a remote printer, for providing a permanent record, and the location of the printer. For example, the user requesting the service is identified via an account name and a password; stored at the server 40 is information corresponding to that account name and password and among that information is the location and access means for a remote printer to be used for that account name and password. Alternatively, the user can provide location and access means for a remote printer to be used for that particular request.

When the communication device 10 is a telephone, the identification the user, the remote printer, and the location of the printer could be accomplished, for example, by using caller ID to identify the telephone number, using the telephone number to identify an account, and access the account information containing the location and access means for a remote printer. Alternatively, the user can provide location and access means for a remote printer to be used for that particular request. It should be apparent that other means, or a combination of the above means, for identifying the user and the remote printer are possible.

If a transaction is needed for the service, as will be the case for obtaining tickets or merchandise, the transaction is completed at a transaction server (step 130, FIG. 5A) using the data necessary to complete the transaction (125, FIG. 5A). It should be apparent, although it is not usual, that the transaction server could be the same server 40 at the receiving center 12. It is, however, common practice to use a separate transaction server operating as a secure server and using a secure protocol. In one embodiment, the exchange of data between the server 40 and the transaction server 80 occurs through a network using a secure protocol (HTTPS, which is Secure HTTP, or Secure Socket Layer, SSL, for example).

The data required for the service, printer information (160, FIG. 5A), and any data relating to print format stored at the server 40 (175, FIG. 5A), are processed at the server 40 to generate input data for the remote printer (step 170, FIG. 5A). The printer information 160 includes a name for the manufacturer and a model number for the specific printer, and/or any other printer descriptor for the specific printer.

Once the transaction is successfully completed, the processing of the request and the generation of the data for the service (165, FIG. 5A) are complete. At that point in the process, a message can be sent, from the server 40, to the communication device 10, or to another device (not shown), confirming that the request for service has been completed (step 145, FIG. 5A). That message can contain information to ensure that, in the event that the permanent record is lost, the user can still obtain the service.

Using the method described in U.S. Pat. No. 5,694,484 (Cottrell et al., System and Method for Automatically Processing Image Data to Provide Images of Optimal Perceptual Quality, issued on Dec. 2, 1997), hereby incorporated by reference herein, in and in U.S. Pat. No. 6,128,415 (Hultgren et al., Device Profiles for Use in a Digital Image Processing System, issued on Oct. 3, 2000), which is also hereby incorporated by reference herein, print data to produce an image of optimal perceptual quality rendered at the specific printer 15 of known characteristics can be generated at the server 40.

The input data for the printer is, then, transmitted to the printer 15 through a communications network 20 (step 180, FIG. 5A). The techniques for coupling the printer 15 to the communications network 20, downloading the input data to the printer 15 and using the printer 15 to generate a permanent record of the service are described in the above referenced commonly-owned and concurrently filed U.S. patent application Ser. No., aa/AAA,AAA, entitled “Method and Apparatus for Printing Remote Images Using of a Network-Enabled Printer” (Atty. Docket No. 8521).

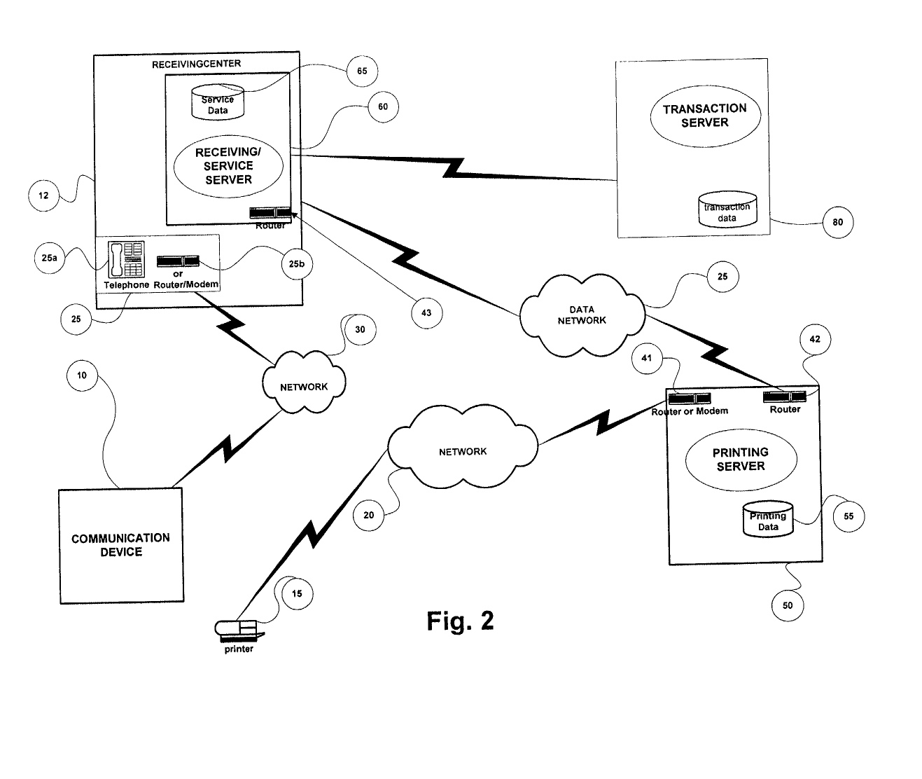

It should be apparent that, although only one server 40 is shown in FIG. 1 to accomplish the functions of receiving, printing and providing the service, more than one server can be used to accomplish the same functions. FIG. 2 depicts a graphical representation of an embodiment of the system of the invention utilizing two servers to accomplish the functions of receiving the request, providing the service and printing the permanent record, namely a receiving and service providing server 60 and a printing server 50. When the system comprises a printing server 50, the method for providing a service and generating, at the location of the remote printer, a permanent record of the service (shown in block diagram in FIG. 5B) is similar to the method used when the system comprises a receiving center with one server used for receiving, providing the service, and printing, shown in FIG. 5A. The method shown in FIG. 5B is the same as the method shown in FIG. 5A up to the step at which the request for service is processed at the receiving center (step 110, FIG. 5A or FIG. 5B). Referring to FIG. 5B, after the request for the service has been processed at the receiving center (step 110, FIG. 5B), the data for the service of it is transmitted to the printing server (step 140, FIG. 5B). The data for the service (165, FIG. 5B), printer information (160, FIG. 5B), and stored data format (175, FIG. 5B) are processed at the printing server 50 to generate the input data for the remote printer (step 190, FIG. 5B). As in FIG. 5A, the input data for the printer is, then, transmitted to the printer 15 through a communications network 20 (step 180, FIG. 5B).

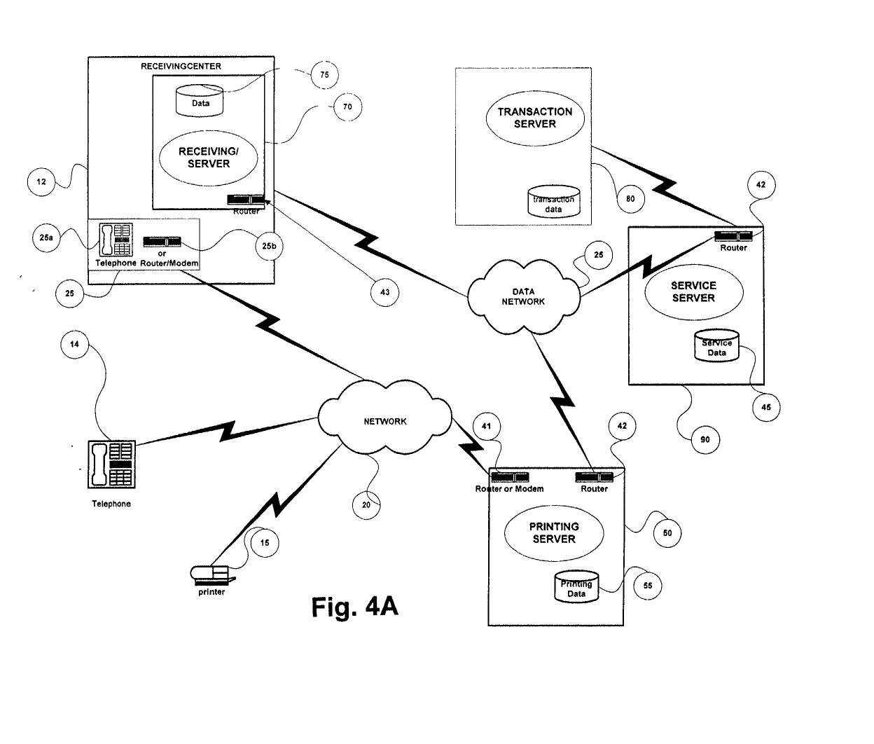

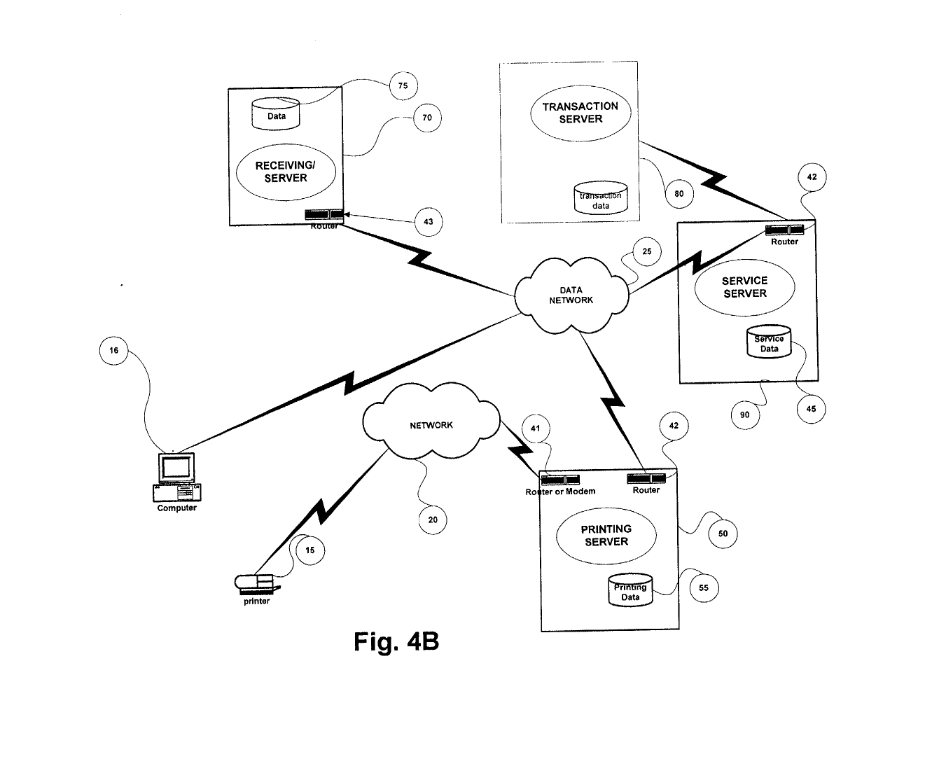

FIGS. 4A and 4B depict a graphical representation of an embodiment of the system of this invention utilizing three servers to accomplish the functions of receiving the request, providing the service and printing the permanent record, namely a receiving server 70 and service providing server 90 and a printing server 50. It should be apparent that the system can comprise a number of servers for intermediate use. It should also be apparent that the same techniques used to generate print data to produce a print of optimal perceptual quality at a specific printer 15 can be used when a printing server 50 is utilized in the system of this invention.

Several detailed embodiments given below will further illustrate the invention.

Sharing Images Via a Data Network

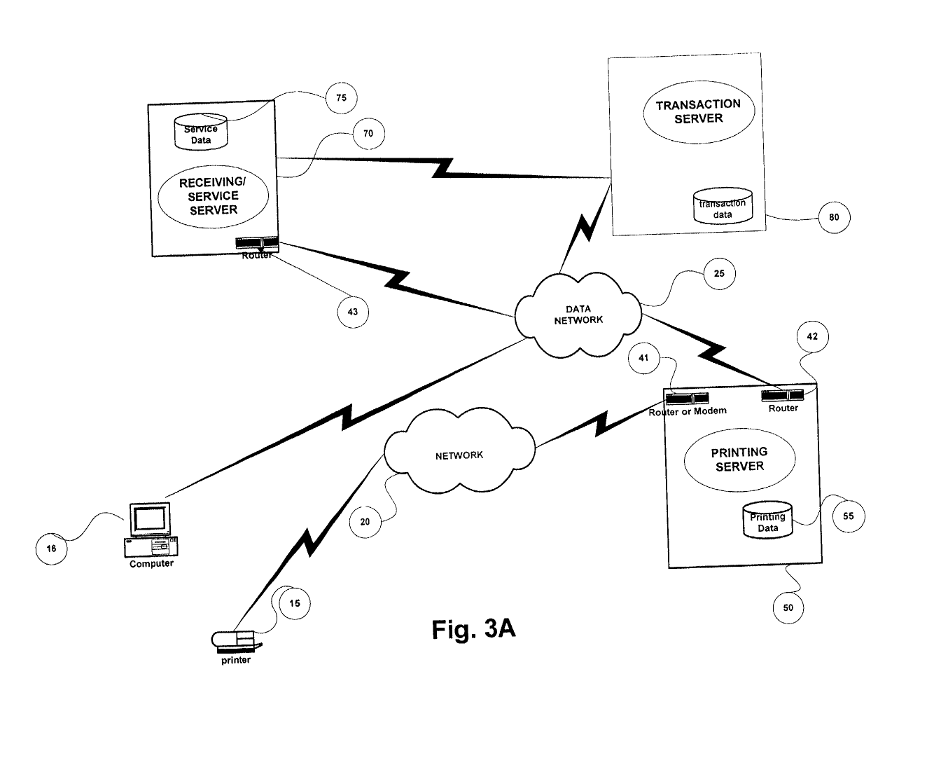

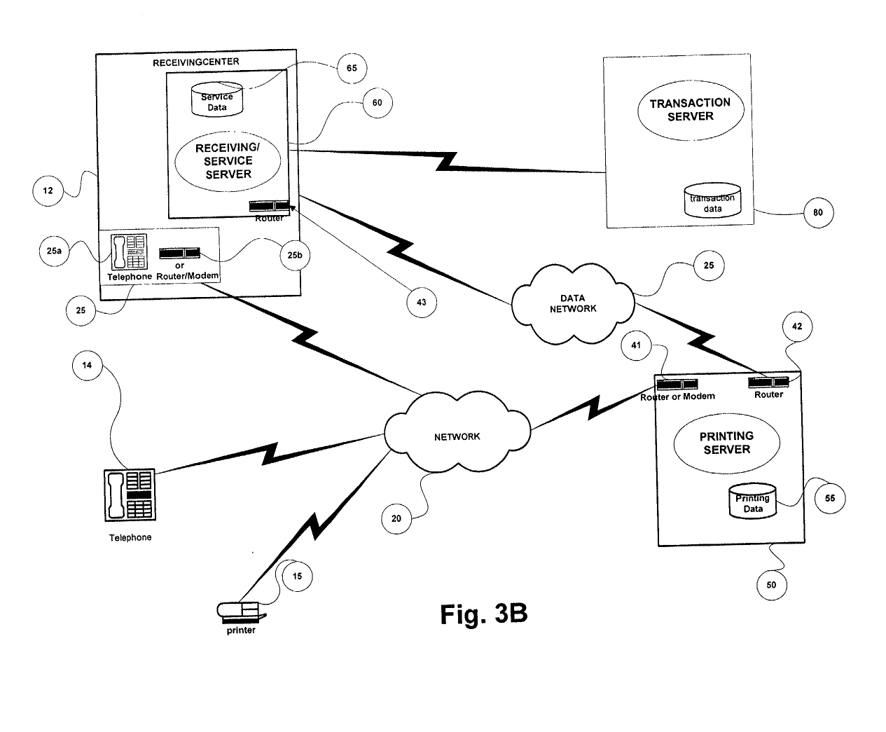

When the method of this invention is used to share images, referring to FIG. 3A, in one embodiment, the communications device 10 (in FIG. 1) is a computer 16 and network 30 (in FIG. 1) is a data network 25. The user of the computer 16 accesses an image either by acquiring the image by means of an acquisition device (not shown), such as a digital camera or a scanner, or by accessing an image file or the thumbnail of an image file stored at the receiving/service server 60. (It should be apparent that the images could reside at a different server, an image server, or that a different server could be used to provide the images.) If the user acquires the image, upon acquisition of the image, the user establishes a connection, via data network 25, with the receiving/service server 60 and downloads the acquired image to the server 60. (When the network is the Internet/World Wide Web, the user establishes the connection with the server 60 by accessing a web site that resides in that server 60.) If the image already exists as an image file at the server 60, the user establishes a connection to the server 60 and receives a thumbnail or a version of the image. Alternatively, the user can view a collection, or album, of images that are stored at the server 60 and the user can select an image from the collection in order to share it. It should be apparent that the image files can reside at a separate server and the accessed by the receiving/service server 60. Having accessed an image, the user then provides to the server 60 contact information (such as a telephone number) for each remote printer 15 at which the image is to be printed. The information needed to access the image, the contact information for each remote printer 15, and any message or annotation to accompany the image constitute the data 120 needed for sharing the image. Transaction data 125, necessary for charging an account, include credit card information, account information and billing information. The receiving/service server 60 transmits the data needed for a transaction 125 to a transaction server 80 and completes the required transaction. In sharing an image, the required transaction can be debiting an account, adding to the count of number of times used for an account, or charging for the service. The required transaction depends on the business model used for the service. Once the transaction is completed and the request for the image sharing is processed at the server 60, the data 165 needed to share the image is generated at the server 60. The data 165 needed to share the image can include the image and any annotations or message. The data 165 needed to share the image is transmitted via the data network 25 to the printing server 50. The routers 42 and 43 provide means for enabling the transmission that provides the data 165 required for sharing the image to the printing server 50.

At this point in the process, a message can be sent, from the receiving/service server 60, to the computer 16, or to another device (not shown), confirming that the request for sharing the images has been completed (step 145, FIG. 5B).

The data required for the service, printer information (160, FIG. 5B), and any data relating to print format stored at the printing server 50 (175, FIG. 5B), are processed at the printing server 50 to generate input data for each remote printer 15 (step 190, FIG. 5B). The printer information 160, for each printer, includes a name for the manufacturer and a model number for the specific printer, and/or any other printer descriptor for the specific printer.

Using the method described in U.S. Pat. No. 5,694,484 and in U.S. Pat. No. 6,128,415, print data to produce an image of optimal perceptual quality rendered at each specific printer 15 of known characteristics can be generated at the printing server 50.

The input data for each printer is, then, transmitted to the specific printer 15 through a communications network 20 (step 180, FIG. 5B). Using the techniques for coupling the printer 15 to the communications network 20, downloading the input data to the printer 15 and using the printer 15 to generate an image, described in the above referenced commonly-owned and concurrently filed U.S. patent application Ser. No., aa/AAA,AAA, entitled “Method and Apparatus for Printing Remote Images Using of a Network-Enabled Printer” (Atty. Docket No. 8521), a shared image is generated at the remote printer 15.

As described in U.S. patent application Ser. No., aa/AAA,AAA, entitled “Method and Apparatus for Printing Remote Images Using of a Network-Enabled Printer” (Docket No. 8521), the printing server 50 may initiate the connection to the remote printer 15 in any of a variety of ways. In one embodiment, the printing server 50 initiates a telephone call to the remote printer 15. In another embodiment, the user may press a “Print” button on the printer 15 to instruct the printer 15 to establish a connection to the printing server 50 and to download and print the input data for the printer. After initiating a connection to the printer 15, the printing server 50 transmits the input data for the printer to the printer 15 over the communications network 20 using an image printing protocol. Printer 15 then prints the ticket.

After sending the input data to the printer 15, another message can be sent from the printing server 50 to the computer 16, or to another device (not shown), confirming that the images for sharing have been sent to the printer (step 145, FIG. 5B).

The modem 41 and a network communications device, such as a modem, at the printer (as described in U.S. patent application Ser. No., aa/AAA,AAA, Docket No. 8521) provide means for enabling the transmission that provides the input data for the printer to the remote printer 15.

The methods of this invention provide the user with capabilities not found in the present practice for sharing images. Under present practice, the user uploads the images to a service and can share the images with another computer user, where the other computer user can view the images but can not obtain prints. Under present practice, if a user desires to share prints of images, the user has to request prints from the service. Using the methods of this invention, a user can upload an image to a service and request that the image be shared with other users who have printers capable of printing images received via a communications network 20. The other users can connect their printers to the communications network 20 and obtain a print of the shared image. The other users need not have a computer or need not have the printer connected to the computer. The methods of this invention greatly expand the capability for sharing images.

It should be apparent that although in the above discussion the communications device 10 was a computer 16, similar systems could use other communication devices. For example, a voice portal (“vortal”) could be used to at the receiving center 12 and, in that embodiment, the communications device 10 would be a telephone

Providing Tickets for an Event Ordered Via a Telephone

Referring to FIG. 3B, in one embodiment, the communications device 10 (in FIG. 1) is a telephone 14 and network 20 is a communications network. The telephone 14 can be a telephone over the POTS network or a wireless phone or any other type of telephone. A user initiates a request for tickets via a phone call over the network 20 to the receiving center 12. The phone call is received at telephone 25 a in the receiving center 12. The phone call initiating the request for service can be, for example, a phone call to a number for a ticket service were the receiving party is a person or a phone call to a voice portal (a “vortal”) providing the ticket service. In the embodiment in which the request for service is received by a person, the data required to provide the service 120 is then provided to be receiving/service server 60. It should be apparent that the phone call requesting the service could also be answered by a computer utilizing voice recognition to obtain the data needed. For a ticket, the data needed to provide the ticket includes the event and the date of event (where the event can be airline travel, a concert, or any other event), other information such as seating information, and billing data. The data needed to provide the ticket can also include contact information (such as a telephone number) for the remote printer 15. The receiving/service server 60 transmits the data needed for a transaction 125 to a transaction server 80 and completes the required transaction. In obtaining a ticket, the required transaction is the purchase of the ticket, and transaction data 125 can include a credit card number or an account number or any other method of completing the sale. Once the transaction is completed and the request for the ticket is processed at the server 60, the data 165 needed to provide the ticket is generated at the server 60. The data 165 needed to provide the ticket includes event information, such as the date, seating information, event location (or in the case of travel, the departing location and arrival location), amount paid for the tickets, images, security features, such as bar-code or similar security identifier, and any advertisement desired. The data 165 required to provide the ticket is transmitted via the data network 25 to the printing server 50. The routers 42 and 43 provide means for enabling the transmission that provides the data 165 needed to provide the ticket to the printing server 50.

The data required for the service, printer information (160, FIG. 5B), and any data relating to print format stored at the printing server 50 (175, FIG. 5B), are processed at the printing server 50 to generate input data for the remote printer 15 (step 190, FIG. 5B). The printer information 160 includes a name for the manufacturer and a model number for the specific printer, and/or any other printer descriptor for the specific printer. the input data for the printer to the printer 15 over the communications network 20 using an image printing protocol. Printer 15 then prints the ticket.

The modem 41 and a network communications device, such as a modem, at the printer (as described in U.S. patent application Ser. No., aa/AAA,AAA, Docket No. 8521) provide means for enabling the transmission that provides the input data for the printer to the remote printer 15.

The method of this invention provides significant advantages over the present practice for obtaining tickets via the telephone or a computer. Under present practice, a consumer can order a ticket and have the ticket mailed or retrieve the ticket at the “will-call” window or a ticket counter. The method of this invention provides the convenience of purchasing a ticket just before the event or of not having to wait in a queue if the ticket is purchased before the event or the time of travel. Using the method of this invention a consumer can purchase the ticket at one location and have the ticket printed at another location. The ability to order to ticket at one location and retrieve it at another location enables the consumer to order tickets for another consumer or retrieve the ticket at the location where the consumer will be at a subsequent time. It should be apparent that, although the above description is based on using a telephone 14 as the communications device 10, a similar method could be implemented using a computer 16 as the communications device 10 (refer to FIG. 3 A).

It should be appreciated that the various embodiments described above are provided merely for purposes of example and do not constitute limitations of the present invention. Rather, various other embodiments are also within the scope of the claims, such as the following.

It should be understood that the service server 70, transaction server 80, printing server 50 and receiving server 60 can be combined in several configurations and any combination performing the functions that allow a user to obtain, at remote printer 15, a permanent record of a service is within the scope of this invention. The servers can be web servers, FTP servers or any form of server performing the required functions.

The computer 16 may be any device that is capable of establishing a connection to data network 25. For example, the computer 16 may be a conventional desktop or laptop computer, Personal Digital Assistant (PDA), or Internet appliance. A user of the computer 16 may establish a connection between the computer 16 and the data network 25 using techniques that are well-known to those of ordinary skill in the art. The computer 16 may connect to the data network 25 using any suitable network connection device.

The network communications devices, used by the printer 15 and by the server 50 or 40, may be any communications device, such as a conventional analog modem, cable modem, Digital Subscriber Line (DSL) modem, or network interface card NIC).

The communications network 20 may be any network or combination of networks. For example, the communications network may be a POTS network, wireless network, Local Area Network (LAN), Wide Area Network (WAN), or an internet such as the public Internet. The printer 15, computer 16, and telephone 14 need not all communicate over the same network. For example, the telephone 14 may communicate with the receiving center 12 over a wireless network, while the printer 15 may communicate with server 40 or 50 over a POTS network. The single communications network 20 is shown in FIGS. 1 through 4 merely for ease of illustration.

Servers 40, 50, 60, 70, and 80 and computer 16 have computational and data storage capabilities and utilize computer readable media that contains the inistructions for the computational operations. The methods of this invention can be implemented as instructions that cause a computer controlled system to execute the method. Common forms of computer-readable media include, for example, a floppy disk, a flexible disk, hard disk, magnetic tape, or any other magnetic medium, a CDROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read. Networks 30 and 25 use electrical, electromagnetic or optical signals that carry digital data streams representing various types of information. The signals through the various networks and through router or modems 41, 42, and 43 which carry the digital data to and from the mobile device 10, servers 40, 50, 70, 80 and 60 are exemplary forms of carrier waves transporting the information. Since communications device 10, servers 50, 70, 80 and 60 exchange digital data, which can include program code, computer 16, server 40, 50, 70, 80 and 60 comprise an exemplary form of a computer controlled system.

Other embodiments of the invention, including combinations, additions, variations and other modifications of the disclosed embodiments will be obvious to those skilled in the art and are within the scope of the following claims.

1. A method of providing a service and generating, at the location of a printer, a permanent record of said service, wherein, before generating the permanent record, data necessary to provide said service and data necessary to provide said permanent record are processed by at least one remote server, said method comprising the steps of:
(A) receiving at a receiving center, from a communications device, a request for the service and said data necessary to provide the service, said receiving center comprising at least one remote server; said data necessary to provide the service being processed to generate data required for the service;
(B) processing said data required for the service and other stored data to generate input data for a specific printer;
(C) transmitting to said printer said input data, said input being rendered by the specific printer as the permanent record of said service.

2. The method of claim 1 wherein the receiving center comprises a receiving server.

3. The method of claim 2 wherein step (B) further comprises the steps of:
providing said data required for the service to a printing server; and
generating the input data for a specific printer at the printing server.

4. The method of claim 1 wherein step (B) further comprises:
completing a transaction at a transaction server, said transaction depending on the requested service, said transaction server being one of said remote servers.

5. The method of claim 2 wherein step (B) further comprises:
completing a transaction at a transaction server, said transaction depending on the requested service, said transaction server being one of said remote servers.

6. The method of claim 1 further comprising the step of sending,
sending, after step (B) a message confirming that the request for service has been fulfilled.

7. The method of claim 2 further comprising the step of:
sending, after step (B) a message confirming that the request for service has been fulfilled.

8. The method of claim 1 wherein step (B) further comprises:
processing the data for the service and other data to generate input data to produce the optimal quality print for a specific printer.

9. The method of claim 2 wherein the receiving server is a printing server.

10. The method of claim 2 wherein the receiving server is a service server.

11. The method of claim 1 wherein the requested service is an event ticket.

12. The method of claim 1 wherein the requested service is a coupon.

13. The method of claim 1 wherein the requested service is an image.

14. The method of claim 1 wherein the requested service is a compound document.

15. A system for providing a service, generating, at the location of a printer, a permanent record of said service, and, before generating the permanent record, processing, utilizing at least one remote server, data necessary to provide said service and data necessary to provide said permanent record, said system comprising:
means for receiving at a receiving center, from a communications device, a request for the service and said data necessary to provide the service, said receiving center comprising at least one remote server; said data necessary to provide the service being processed to generate data required for the service; and,
means for processing said data required for the service and other stored means for transmitting to said printer said input data, said input being rendered by the specific printer as the permanent record of said service.

16. The system of claim 15 further comprising:
means for completing a transaction at a transaction server, said transaction depending on the requested service, said transaction server being one of said remote servers.

17. The system of claim 15 further comprising:
means for sending, after processing the data required for the service, a message confirming that the request for service has been fulfilled.

18. The system of claim 15 further comprising:
means for processing the data for the service and other data to generate input data to produce the optimal quality print for a specific printer.

19. The system of claim 15 wherein the requested service is an event ticket.

20. The system of claim 15 wherein the requested service is a coupon.

21. The system of claim 15 wherein the requested service is an image.

22. The system of claim 15 where in the requested service is a compound document.

23. The system of claim 15 wherein the receiving center comprises a receiving server.

24. The system of claim 15 further comprising:
means for providing said data required for the service to a printing server; and
means for generating the input data for a specific printer at the printing server.

25. A computer program product comprising:
a computer readable medium having computer readable code embodied therein for providing a service and generating, at the location of a printer, a permanent record of said service, said service and said permanent record being processed by at least one remote server, said code causing a computer controlled system to:
receive at a receiving center, from a communications device, a request for the service and data necessary to provide the service, said receiving center comprising at least one remote server; said data necessary to provide the service being processed to generate data required for the service;
process said data required for the service and other stored data to generate input data for a specific printer;
transmit to said printer said input data, said input being rendered by the specific printer as the permanent record of said service.

26. The computer program product of claim 25 wherein the computer readable code further causes the computer controlled system to:
complete a transaction at a transaction server, said transaction depending on the requested service, said transaction server being one of said remote servers.

27. The computer program product of claim 25 wherein the computer readable code further causes the computer controlled system to:
send, after processing the data for the service, a message confirming that the request for service has been fulfilled.

28. The computer program product of claim 25 wherein the computer readable code further causes the computer controlled system to:
process the data required for the service and other data to generate input data to produce the optimal quality print for a specific printer.

30. The computer program product of claim 25 wherein the receiving center comprises a receiving server.

31. The computer program product of claim 29 wherein the computer readable code further causes the computer controlled system to:
provide said data required for the service to a printing server; and
generate the input data for a specific printer at the printing server.
